(19) United States
(12) Patent Application Publication
(10) Pub. No.: US 2024/0095243 A1
(43) Pub. Date: Mar. 21, 2024

(54) COLUMN-BASED UNION PRUNING

(71) Applicant: SAP SE, Walldorf (DE)

(72) Inventors: Christoph WEYERHAEUSER, Leimen (DE); Simon Spohrer, Mannheim (DE); Jan Zwickel, Wiesloch (DE); Mohamed Ali Chriki, Leiman (DE); Feipeng Ru, Xi'am (CN)

(21) Appl. No.: 17/933,212

(22) Filed: Sep. 19, 2022

(51) Int. Cl. G06F 16/2453; G06F 11/34; G06F 16/242

(52) U.S. Cl. CPC G06F 16/24537; G06F 11/3419; G06F 16/244

(57) ABSTRACT

In one aspect, a method may include receiving a query associated with a plurality of data sources, wherein the query includes a first attribute; identifying that a query operator, which is associated with execution of the query and the first attribute, includes a first input from a first data source of the plurality of data sources and a second input from a second data source of the plurality of data sources; determining that the first attribute at the second data source corresponds to null; pruning, based on the determined null, the second input from the second data source to inhibit a select from the second data source; and in response to the pruning, performing the query operator by selecting, from the first data source, a column corresponding to the first attribute. Related systems, methods, and articles or manufacture are also disclosed.

### TECHNICAL FIELD

The subject matter described herein relates to optimization of database queries.

### BACKGROUND

Database management systems have become an integral part of many computer systems. For example, some systems handle hundreds if not thousands of transactions per second (which in-turn can generate over time a large volume of corresponding data). On the other hand, some systems perform very complex multidimensional analysis on data. In both cases, the underlying database may need to handle responses to queries very quickly in order to satisfy systems requirements with respect to transaction time. Given the complexity of these queries and/or their volume, the underlying databases face challenges in order to optimize performance including use of resources, such as memory and storage.

### SUMMARY

Systems, methods, and articles of manufacture, including computer program products, are provided. In one aspect, a method may include receiving a query associated with a plurality of data sources, wherein the query includes a first attribute; identifying that a query operator, which is associated with execution of the query and the first attribute, includes a first input from a first data source of the plurality of data sources and a second input from a second data source of the plurality of data sources; determining that the first attribute at the first data source does not correspond to null; determining that the first attribute at the second data source corresponds to null; pruning, based on the determined null, the second input from the second data source to inhibit a select from the second data source; in response to the pruning, performing the query operator by selecting, from the first data source, a column corresponding to the first attribute; and in response to the performing, responding to the query with a result using at least in part the selected column corresponding to the first attribute at the first data source.

In optional variations, one or more additional features, including but not limited to the following can be included in any feasible combination. The query is associated with a calculation scenario. The first attribute comprises a key figure attribute. The key figure attribute is flagged in the calculation scenario to allow pruning of the second input to the query operator. The query operator is flagged to allow pruning. Metadata is used to determine that the key figure attribute at the first data source does not correspond to null. Metadata is used to determine that the key figure attribute at the first data source does correspond to null. The query operator comprises a union operator. The union operator includes the first input from the first data source and the second input from the second data source. The query associated with the calculation scenario further defines a view attribute associated with at least the first data source and the second data source.

Systems and methods consistent with this approach are described as well as articles that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts an example of a model comprised as a calculation scenario, in accordance with some embodiments;

FIG. 1B depicts an example where in the design time a given union operator is enabled for pruning, in accordance with some embodiments;

FIG. 1C depicts an example of the model of FIG. 1A with an input to a union operation is pruned, in accordance with some embodiments;

FIG. 1D depicts another example of the model of FIG. 1A with another input to a union operation pruned, in accordance with some embodiments;

FIG. 2A shows a block diagram of a computing architecture, in accordance with some embodiments;

FIG. 2B shows another block diagram illustrating a sample architecture for request processing and execution control, in accordance with some embodiments;

FIG. 3 shows another example of a calculation scenario, in accordance with some embodiments;

FIG. 4 shows an example of a calculation scenario including a semantic node, in accordance with some embodiments;

FIG. 5 shows an example of a process for column-based union pruning, in accordance with some embodiments; and

FIG. 6 shows another example of a system, in accordance with some embodiments.

When practical, similar reference numbers denote similar structures, features, or elements.

### DETAILED DESCRIPTION

In many systems, a calculation scenario can be used to provide a model (or data flow graph) of operations performed in response to a query. Often, the calculation may include a union operation that needs access to one or more data sources to select items for the union. The union operation refers to an operation that combines the results obtained frog a plural plurality of select operations (or queries) to corresponding data sources, without duplication of the results. The data source may refer to one or more tables of a database, such as a column-store database, row-store database, or a hybrid of the two. To illustrate further, the union operation may remove duplicate rows among the various select operations (or statements) to the data sources. And, each select operation within the union operation should have the same number of fields in the result set with similar data types. As such, the data sources of a union operation need to provide all the attributes for the union. However, if a data source does not possess all the necessary attributes, the missing attributes can be represented at the data source with a NULL value (e.g., a marker or value to indicate the value of the attribute does not exist in the selected table of the data source or with a substitute constant value to indicate the NULL condition).

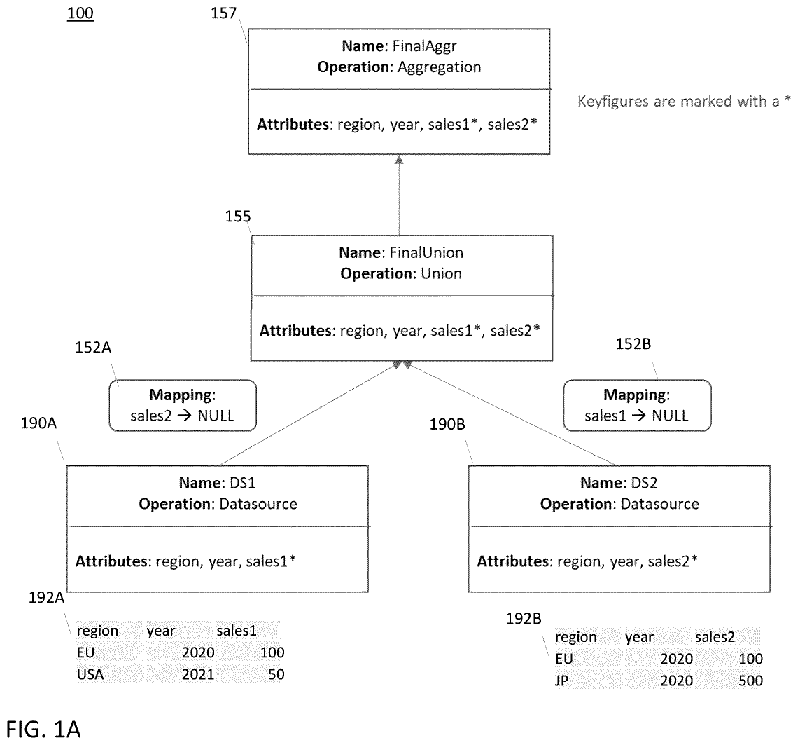

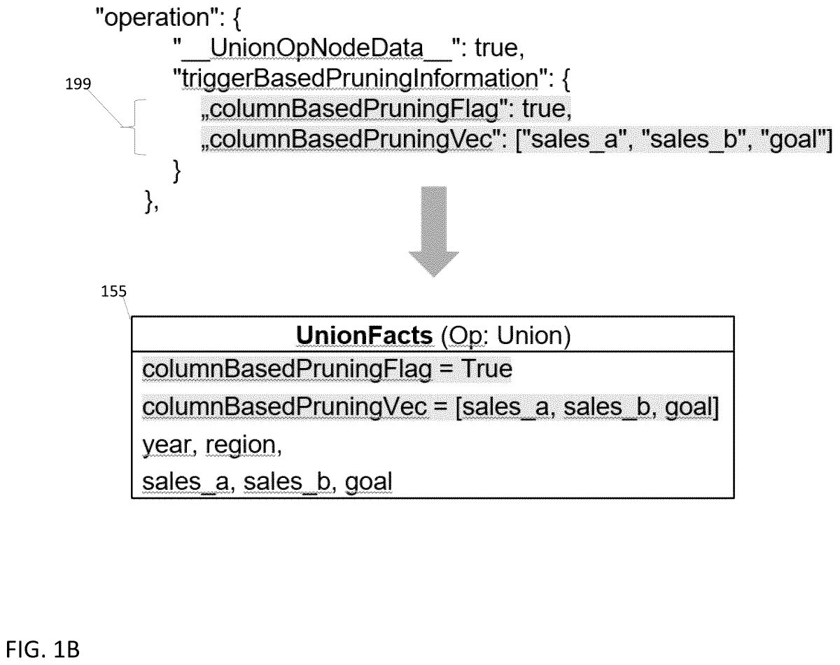

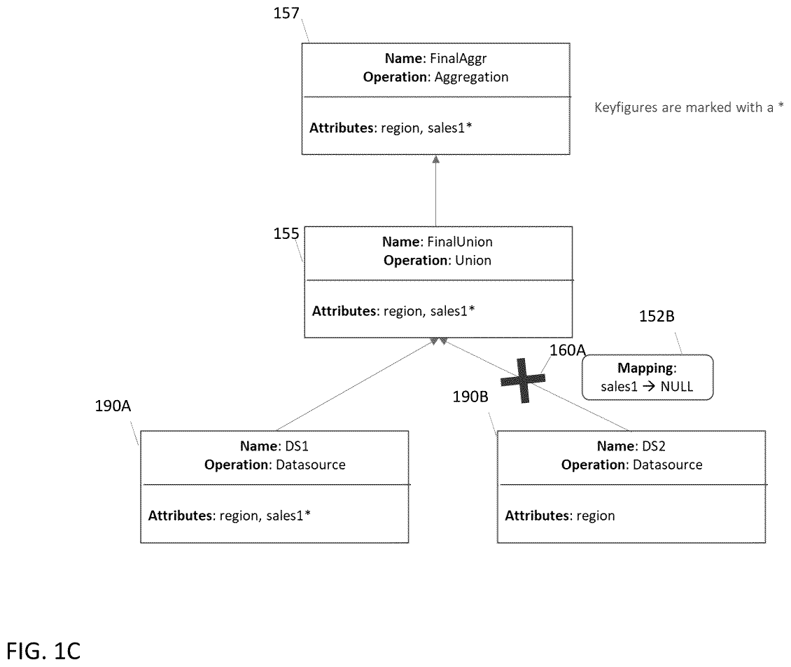

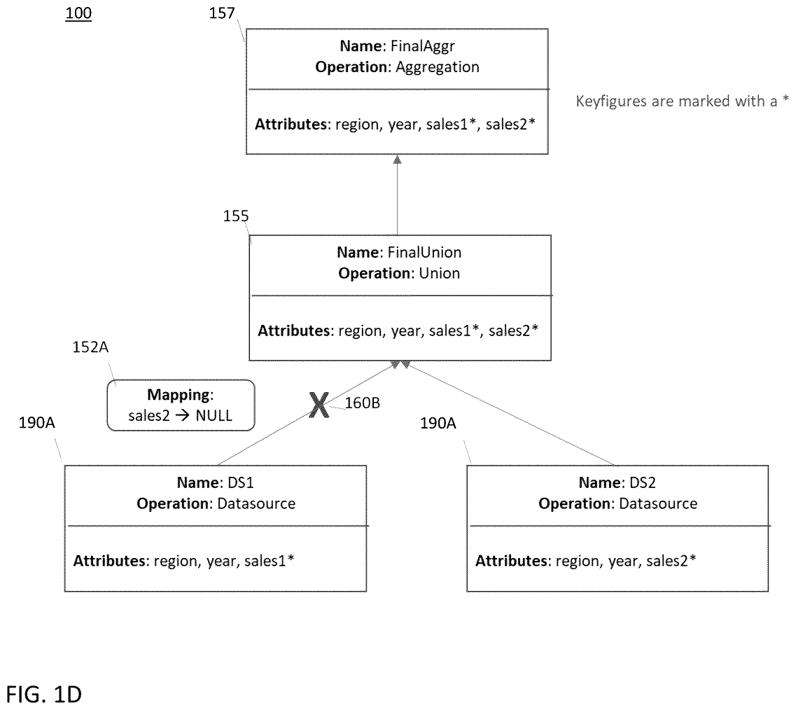

FIG. 1A depicts an example of a model, which in this example is a calculation scenario 100, in accordance with some embodiments. The calculation scenario may be created at design time. After design time when a query is received (which represents query execution time), the calculation scenario is used as a model to guide execution of the query in an efficient, such as an optimized way. At FIG. 1A, the calculation scenario is designed to include an aggregation operation 157 that receives the results of a union operation 155. An aggregation operation collects a set of attributes and returns a single value, examples of which include count, sum, average, min, and the like.

At FIG. 1A, the union operation 155 includes two inputs (“union inputs”) from a first data source (DS1) 190A and a second data source 190B. Here, the first data source includes attributes (which can be selected or queried) of region, year, and sales1. For example, the first data source may include a database table 192A having columns with attributes of region, year, and sales1 (although the attributes may be alternatively organized by rows as well). In this example, the first data source has NULL values 152A for all the values of the sales2 attribute. Likewise, the second data source may include a database table 192B having columns with attributes of region, year, and sales2. However, the second data source has NULL values 152B for the sales1 attribute. The data sources 190A-192B may be comprised in the same database or different databases (e.g., the database tables 192A-B may be contained in the same or different databases).

The indication that an attribute is all NULLs may be stored as metadata by the calculation scenario. The calculation scenario contains the information that “sales1” is mapped to NULL for the second input (152B).

In the example of FIG. 1A, the attributes can be categorized as a key figure or a view attribute. The phrase key figure attributes refers to attributes that are typically aggregated (e.g., attributes such as sales, costs, etc.). The phrase view attributes are attributes that are typically used for grouping, such as grouping by region or year. In the example of FIG. 1A, the key figures correspond to sales1 and sales2 (which are attributes that can be summed, for example), while the view attributes correspond to region or year (which are attributes typically used to group the results by). If region and sales1 are requested by the aggregation 157 as part of a query request, the sales1 would be grouped by region and then aggregated (e.g., summed). To accomplish this, a query (or select) is performed to the first and second data sources 190A-B. However, the second data source 190B only provides NULL values 152B for the sales1 attribute. As such, a query (or select) for sales1 attributes from the second data source 190B does not influence the outcome of the union and, more worrisome, wastes or resources (e.g., processing associated with performing a select to the second data source 190B including scanning/reading database table 192B).

Referring again to the data sources 190A-B, one or more of the data sources may comprise a database. For example, a data source may comprise an online transaction processing (OLTP) system using a relational database system. An example of an OLTP system is the SAP S/4HANA™ enterprise resource planning (ERP) system. Furthermore, the data sources 190A-B may operate using for example the same or different storage technology, such as a row-oriented database system, a column-oriented database system, or a hybrid row-column store approach. Alternatively, or additionally, a data source 190A may be for example an online analytic processing (OLAP) system using the same or different storage technology as the data source 190B. Applications of OLAP systems include business reporting for sales, marketing, management reporting, business process management (BPM), budgeting, forecasting, financial reporting, and/or other types of analytics. An example of the OLAP system is the SAP BW/4HANA™ data warehouse solution, which can be used to for example answer multi-dimensional analytical (MDA) queries. Alternatively, or additionally, a data store may comprise or be comprised in a cloud store (which can be used to store of persist the data processed by a database). Examples of the cloud stores include SAP™ data centers, Microsoft Azure™ data centers, Amazon Web Services™ data centers, Alibaba Cloud™ data centers, Google Cloud Platform™ data centers, a private data center, and/or the like.

A special use case where the noted NULL problem might occur is when star schemas are modeled with calculation scenarios. In this special use case, it is typical that the union data sources all possess the view attributes of the union, so only the key figures of the union are mapped to NULL for the different data sources. In a star join calculation scenario for example, there are facts (which may consist of key figures) that are to be aggregate. The star join is a cascade of joins adding dimensions like time information, master data, and labels. In the case the facts are coming from different sources and brought together by a union operation, the column based union pruning disclosed herein may be used reduce the amount of data (as well as processing and other resources) that has to be transferred as part of the union operation.

The example of FIG. 1A shows the unnecessary processing of an input from a data source, (e.g., the data source 190B) to a union operation. In some embodiments, there is provided a way to prune inputs to a union operation during query execution time such that the pruning is based on which queried attributes are mapped to NULL for an input to the union operation. Special handling for cases in which only the key figures are mapped to NULL should also be possible. Although some of the examples refer to pruning a union input based on nulls in the key figures, other types of attributes including view attributes may be pruned as well given the NULL or other constant as disclosed herein. For example, if column based union pruning is enabled for a given calculation scenario, the pruning can be applied to various types of attributes (e.g., given that the attribute is part of a pruning list or vectors (see, e.g., FIG. 1B) for column based union pruning.

In some embodiments, there is provided pruning of inputs to union operations at query execution time (e.g., runtime) based on which queried attribute is not necessary to the outcome of the union operation (e.g., a queried attribute maps to NULL for all of its values at a data source). In some embodiments, the union input pruning is limited to union inputs corresponding to key figures of a union.

The noted pruning of data sources input to a union operation may include a design time aspect as noted, when the calculation scenario is created. During the creation of the calculation scenario, a designer (e.g., a design tool) of the calculation scenario may decide which union operations of a calculation scenario should be activated (or enabled) to allow the pruning of input data sources to a union operation. For example, the pruning of input data sources to a union operation may be deactivated by default, so activation would selectively activate which union operators allow input pruning.

When pruning is activated, the pruning of input data sources to a union operation (also referred to herein as “union input pruning,” for short) may be configured by explicitly selecting which (1) union operators in a calculation scenario have the union input pruning activated and/or (2) identify the attributes of the union considered for pruning. FIG. 1B depicts an example where the design time activates a given union operator 155 (as shown at 199) by setting the column based pruning flag to “true” and selecting the attributes for the column based pruning vector (e.g., “sales_a”, “sales_b*”, and “goal”). Based on these selected attributes, a query execution engine may decide to prune certain inputs to a union operator 155, in accordance with some embodiments. At query execution time, certain attributes are requested for a union. For example, if an attribute required for a received query that requires a union is flagged/marked (as noted at (1) and (2)) and the attribute has all NULLs at a given data source, the given data source's input to the union operator gets pruned.

FIG. 1C depicts the calculation scenario of FIG. 1A with the pruning of the inputs (from a data source) into a union operation, in accordance with some example embodiments. When a query is received that aggregates sales 1 grouped by region, the input 160A may be pruned as the attribute sales1 is all NULL at the second data source 190B. In this example, the union operator 155 may be flagged to allow the union input pruning and the attribute sales1 may also be flagged/marked (see, e.g., 199 above). It is interesting to note that if the union input pruning was deactivated at FIG. 1C, each of the data sources would be queried by a select as the view attribute region has key figure data across both data sources 190A-B.

FIG. 1D depicts the calculation scenario of FIG. 1A with the pruning of the inputs (from a data source) into a union operation, in accordance with some example embodiments. When a query is received that aggregates sales 2 grouped by region, the input 160B may be pruned as the attribute sales2 is all NULL at the first data source 190A. In this example, the union operator 155 may be flagged to allow the union input pruning and the attributes region and sales2 may also be flagged/marked (see, e.g., 199 above).

Before providing additional details regarding the union input pruning optimization, the following provides some additional details regarding examples of the computing environment.

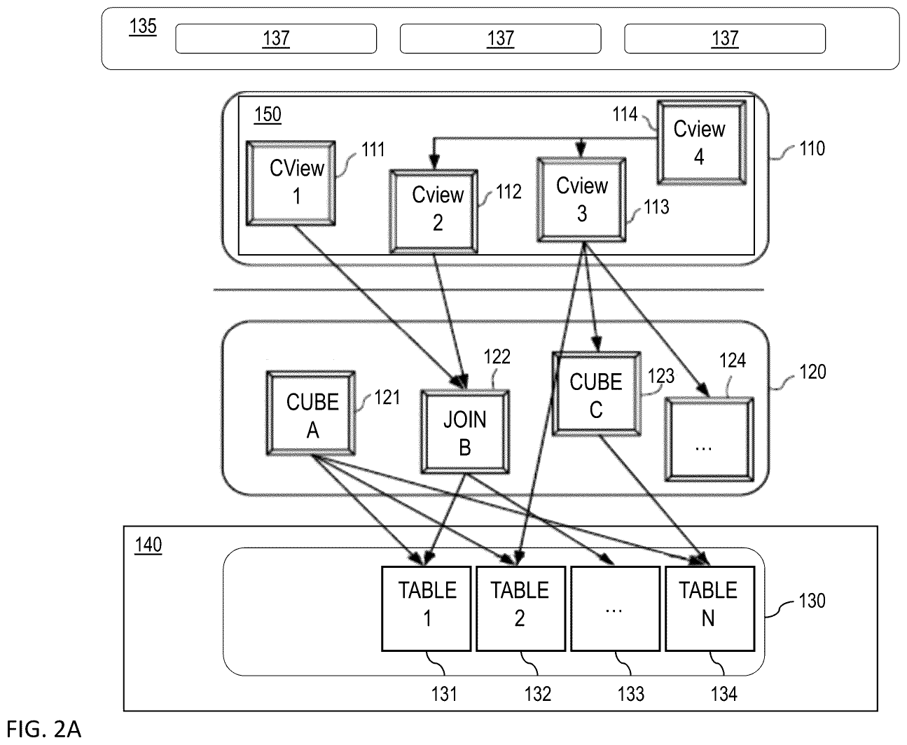

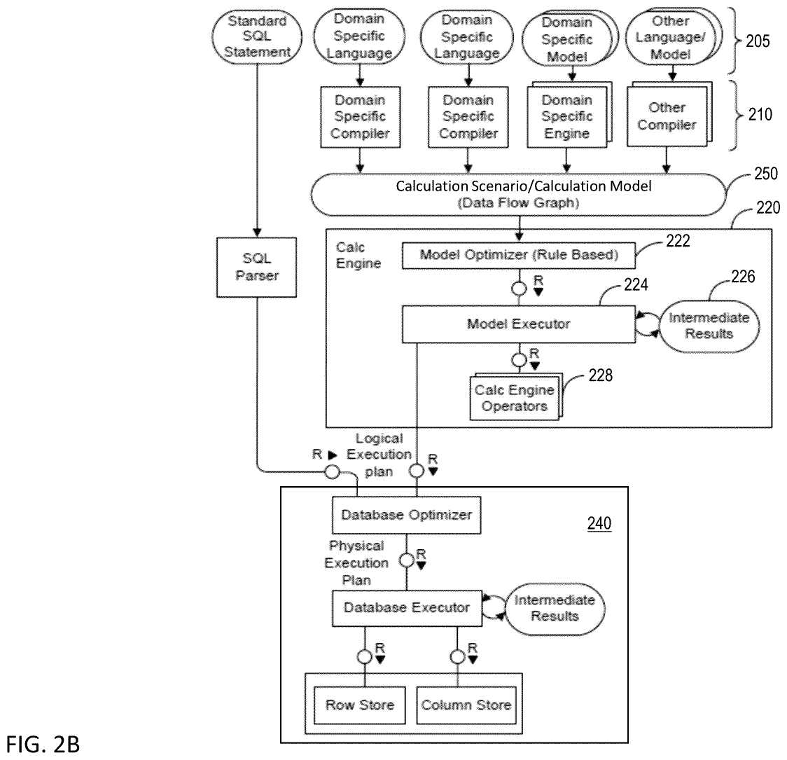

FIG. 2A is a diagram that illustrates a computing architecture including a database system that includes three layers: a calculation engine layer 110, a logical layer 120, and a physical table-pool 130. One or more application servers 135 implementing database client applications 137 may access the database system. Calculation scenarios may be executed by a calculation engine, which may form part of a database or which can be part of the calculation engine layer 110 (which is associated with the database). The calculation engine layer 110 can be based on and/or interact with the other two layers, the logical layer 120 and/or the physical table pool 130. The basis of the physical table pool 130 consists of physical tables (called indexes) containing the data, which can be stored on one or more database servers 140. Various tables 131-134 can be joined using logical metamodels 121-124 defined by the logical layer 120 to form an index. For example, the tables 131-134 in the illustrated Cube A metamodel 121 (e.g., an online analytical processing or “OLAP” index or other type of data structure) can be assigned roles (e.g., fact or dimension tables) and be joined to form a star schema or other type of schema. It is also possible to form join indexes (e.g. the Join B metamodel 122), which can act like database views in computing environments, such as the Fast Search Infrastructure (FSI) available from SAP SE of Walldorf, Germany.

As stated above, a calculation scenario 150 can include individual nodes 111-114 (e.g., calculation views), which in turn each define operations such as unions, aggregations, joins, and/or other physical or logical operations. That is, the input for a node 111-114 can be one or more of a relational operation, a non-relational operation, or another node 111-114.

In a calculation scenario 150 and/or calculation view node 111-114, two different representations can be provided including a pure calculation scenario in which all possible attributes are given and an instantiated model (also referred to herein as “optimized calculation scenario”) that contains only the attributes requested in the query (and required for further calculations). Thus, calculation scenarios can be created that can be used for various queries. With such an arrangement, a calculation scenario 150 can be created which can be reused by multiple queries even if such queries do not require every attribute specified by the calculation scenario 150. Similarly, calculation views (e.g., nodes 111-114) may be created so that they may be reused in multiple calculation scenarios 150. This reusability can provide for simplified development of database queries.

Every calculation scenario 150 can be uniquely identifiable by a name (e.g., the calculation scenario 150 can be a database object with a unique identifier or some other indicia). Accordingly, the calculation scenario 150 can be queried in a manner similar to a view in a SQL database. Thus, the query is forwarded to the calculation node 111-114 for the calculation scenario 150 that is marked as the corresponding default node. In addition, a query can be executed on a particular calculation node 111-114 (as specified in the query). Furthermore, nested calculation scenarios can be generated in which one calculation scenario 150 is used as source in another calculation scenario (e.g. via a calculation node 111-114 in this calculation scenario 150). Each calculation node 111-114 can have one or more output tables. One output table can be consumed by several calculation nodes 111-114.

FIG. 2B is a diagram illustrating a sample architecture for request processing and execution control. As shown in FIG. 2B, artifacts 205 in different domain specific languages can be translated by their specific compilers 210 into a common representation called a “calculation scenario” 250 (which may also be referred to as a calculation model). Calculation scenario 250 may be similar to the calculation scenario 150 of FIG. 2A. To achieve enhanced performance, the models and programs written in these languages can be executed inside a database server 240 (which may be similar to the database server 140). This arrangement eliminates the need to transfer large amounts of data between the database server 240 and a client application 137, which can be executed by the application server 135. Once the different artifacts 205 are compiled into this calculation scenario 250, they can be processed and executed in the same manner. A calculation engine 220 optimizes and/or executes the calculation scenarios 215. At least a portion of the illustrated architecture 200 may be implemented as a database management system (e.g., not including the artifacts 205).

The calculation scenario 250 can be represented as a directed acyclic graph with arrows representing data flows and nodes that represent operations, such as union, aggregation, and/or the like. Each node includes a set of inputs and outputs and an operation (or optionally multiple operations) that transforms the inputs into the outputs. In addition to their primary operation, each node can also include a filter condition for filtering the result set. The inputs and the outputs of the operations can be table valued parameters (e.g., user-defined table types that are passed into a procedure or function and that provide an efficient way to pass multiple rows of data to a client application 137 at the application server 135). Inputs can be connected to tables or to the outputs of other nodes. A calculation scenario 250 can support a variety of node types such as (i) nodes for set operations such as projection, aggregation, join, union, minus, intersection, and (ii) SQL nodes that execute a SQL statement that is an attribute of the node. In addition, to enable parallel execution, a calculation scenario 250 can contain split and merge operations. A split operation can be used to partition input tables for subsequent processing steps based on partitioning criteria. Operations between the split and merge operation can then be executed in parallel for the different partitions. Parallel execution can also be performed without split and merge operation such that all nodes on one level can be executed in parallel until the next synchronization point. Split and merge allows for enhanced/automatically generated parallelization. If a user knows that the operations between the split and merge can work on portioned data without changing the result, they can use a split. Then, the nodes can be automatically multiplied between split and merge and partition the data.

The calculation scenario 250 can be defined as part of database metadata and invoked once or multiple times. The calculation scenario 250 can be created, for example, by a SQL statement “CREATE CALCULATION SCENARIO <NAME>USING <XML or JSON>”. Once a calculation scenario 250 is created, it can be queried (e.g., “SELECT A, B, C FROM <scenario name>”, etc.). In some cases, databases can have pre-defined calculation scenarios 215 (e.g., defaults, those previously defined by users, etc.). Calculation scenarios 215 can be persisted in a repository (coupled to the database server 240) or in transient scenarios. Calculation scenarios 215 can also be kept in-memory.

Calculation scenarios 215 may be considered more powerful than traditional SQL queries or SQL views for many reasons. One reason is the possibility to define parameterized calculation schemas that are specialized when the actual query is issued. Unlike a SQL view, a calculation scenario 250 does not describe the actual query to be executed. Rather, it describes the structure of the calculation. Further information is supplied when the calculation scenario is executed. This further information can include parameters that represent values (for example in filter conditions). To provide additional flexibility, the operations can optionally also be refined upon invoking the calculation model. For example, at definition time, the calculation scenario 250 may contain an aggregation node containing all attributes. Later, the attributes for grouping can be supplied with the query. This allows having a predefined generic aggregation, with the actual aggregation dimensions supplied at invocation time. The calculation engine 220 can use the actual parameters, attribute list, grouping attributes, and/or the like supplied with the invocation to instantiate a query specific calculation scenario 250. This instantiated calculation scenario 250 is optimized for the actual query and does not contain attributes, nodes, or data flows that are not needed for the specific invocation.

When the calculation engine 220 receives a request to execute a calculation scenario 250, it can first optimize the calculation scenario 250 using a rule based model optimizer 222. Examples for optimizations performed by the model optimizer 222 can include “push down” filters and projections so that intermediate results 226 are narrowed down earlier during compilation or execution, or the combination of multiple aggregation and join operations into one node. The optimized model can then be executed by a calculation engine model executor 224 (a similar or the same model executor can be used by the database directly in some cases). This includes decisions about parallel execution of operations in the calculation scenario 250. The model executor 224 can invoke the required operators (using, for example, a calculation engine operators module 228) and manage intermediate results 226. Most of the operators can be executed directly in the calculation engine 220 (e.g., creating the union of several intermediate results 226). The remaining nodes of the calculation scenario 250 (not implemented in the calculation engine 220) can be transformed by the model executor 224 into a set of logical database execution plans. Multiple set operation nodes can be combined into one logical database execution plan if possible. The calculation engine 220 may provide an optimizer for optimization of query execution and this optimizer may be in addition to (e.g., separate from) any optimizer providing for the database (see, e.g., 240).

The attributes of the incoming datasets utilized by the rules of model optimizer 222 can additionally, or alternatively, be based on an estimated and/or actual amount of memory consumed by the dataset, a number of rows and/or columns in the dataset, and the number of cell values for the dataset, and the like.

The calculation scenario 250 as described herein can include a type of node referred to herein as a semantic node (or sometimes semantic root node). In some aspects, a database modeler can flag the root node (output) in a graphical calculation view to which the queries of the database applications are directed as semantic node. This arrangement allows the calculation engine 220 to easily identify those queries and to thereby provide a proper handling of the query in all cases.

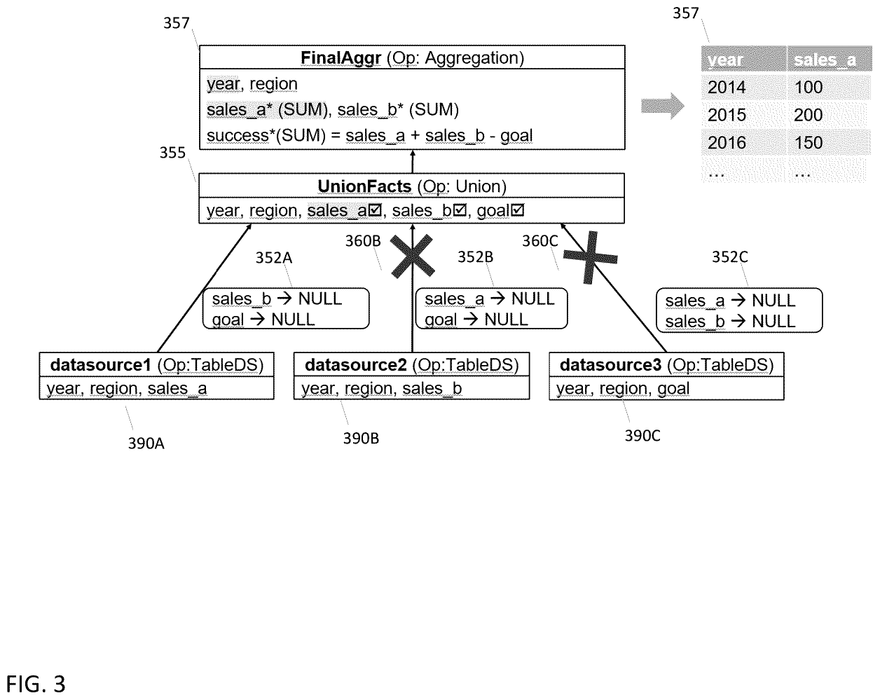

FIG. 3 depicts another example of a calculation scenario, which is similar in some respect to the calculation scenario of FIG. 1A above but with additional data sources 390A-C. At FIG. 3, a query is received for sales_a* (SUM) grouped by year. In this example, the union input pruning is enabled (or activated) and the attributes at union operation 355 are marked (or flagged) as keyfigure attributes (e.g., sales_a, sales_b, and goal). Here, the received query requires a union of the keyfigure sales_a* across data sources 390A-390C since the view attribute year implicates (or is associated with) data at all three data sources 390A-C. However, the sales_a* attribute is NULL at both data sources 390B and 390C, so these two data sources 390B and 390C can be pruned, so when executing the query, the select is only performed at data source 1 390A (and no selects, scans, reads, or access is performed at data sources 390B and 390C for the NULL sales_1). If union input pruning were deactivated, a select would query each of the data sources, wasting thus processing resources by performing selects at data sources 390B and 390C just to obtain NULLs which do not affect the result set.

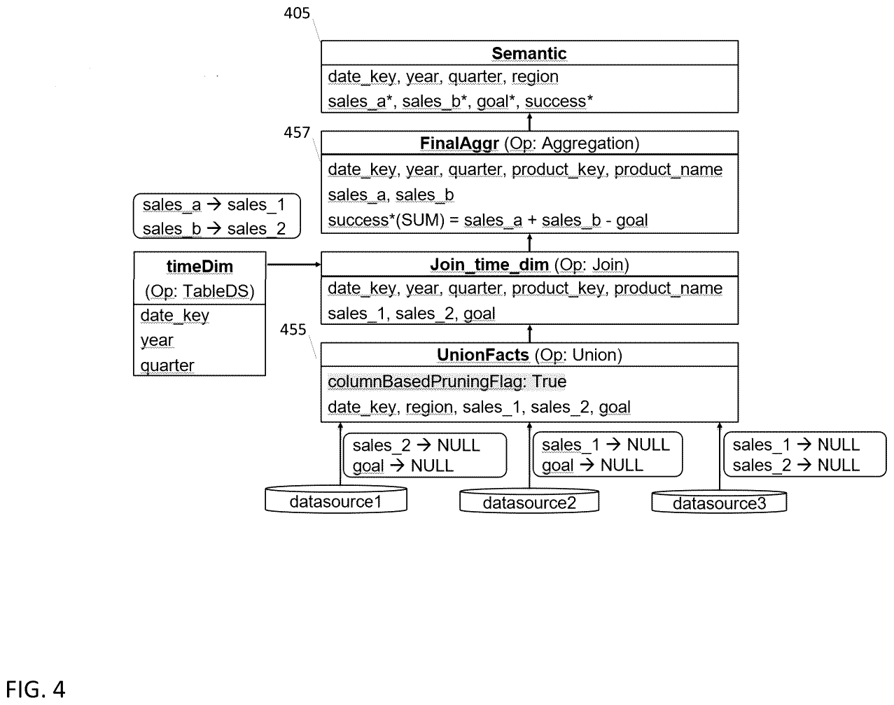

FIG. 4 depicts another example of a calculation scenario, in accordance with some embodiments. In this example, a semantic node 405 is shown. The semantic node may include metadata regarding some of the attributes used in the calculation scenario. And, the union operation 455 has union input pruning activated (see, e.g., “True”). However, the metadata at the semantic node cannot be used without performing an in depth search of the calculation scenario to identify the union operator at 455 for example and to determine whether any of the attributes of the union operator 455 have under gone a name change. In this example, the in depth search traverses the calculation scenario to determine that the union operator's attributes (e.g., sales_1 and sales_2) do undergo a name change at the aggregation operation 457 (e.g., to sales_a and sales_b). As such, when a received query indicates sales_a* for example, sales_a* is mapped in metadata to sales_1, so that union input pruning can take place using the proper names of the attributes at 455.

Although some of the examples depicts a certain quantity of attributes and data sources, these are merely examples as other quantities of attributes and data types may be implemented as well.

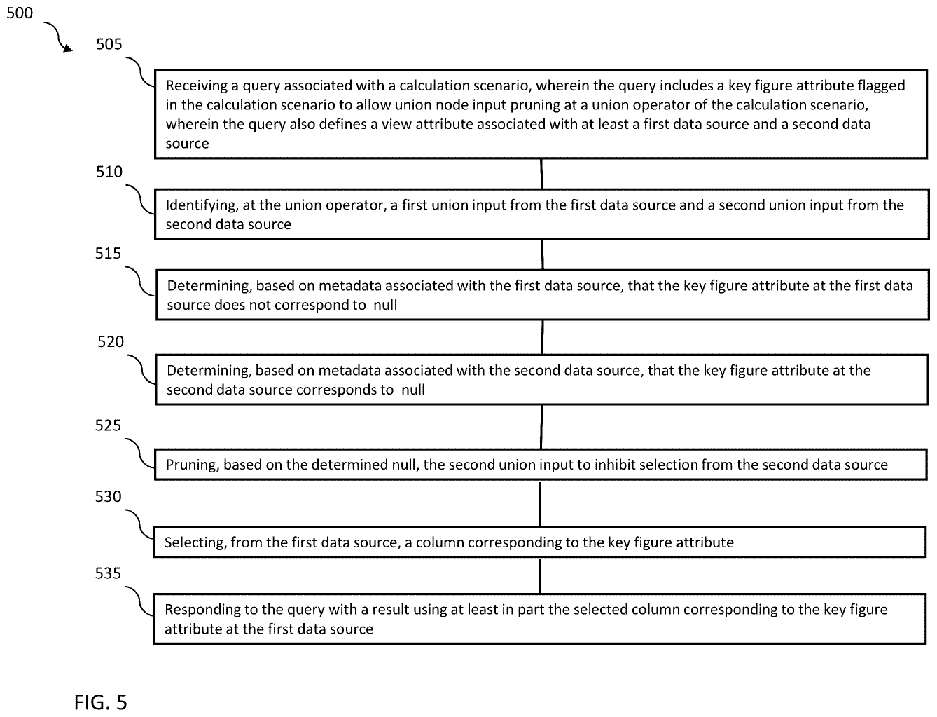

FIG. 5 depicts a design time process for column-based union pruning, in accordance with some embodiments.

At 505, a query is received. The received query may be associated with a calculation scenario. Referring to the calculation scenario at FIG. 3 for example, the query includes a key figure sales_a and a view attribute of year. The key figure attribute is flagged (e.g., at design time of the calculation scenario as noted above with respect to FIG. 1B) to allow union node input pruning at a union operator of the calculation scenario. To illustrate further, the query may request the sales_a attribute to be summed and the result grouped by view attribute year. In the example, union operator 355 combines the attributes for sales_a, which can be at any of the data sources 390A-C.

In the calculation scenario of FIG. 3 for example, there are 3 options to provide data for a column: data is stored in a table (e.g., row, columns, hybrid, etc.) and the data is returned as it is stored in this table; constant mapping in which a column is mapped to a constant value for all values (e.g., YEAR 2020 at data source 1 and YEAR 2021 at data source 2); and a calculated column. In the case of the calculated column, this may be considered more flexible than the constant mapping. In FIG. 3 for example, the success column is calculated column calculated out of sales_a, sales_b and goal). It is also possible to e.g. use now( ) as expression to get a timestamp or use a constant value as expression “to_nvarchar(‘42’)”. Here, any of the 3 options may be used for a column, so long as pruning is enabled for a specific column. And, in the noted example of constant mapping, the constant is mapped to a NULL to enable pruning.

At 510, a first union input from the first data source and a second union input from the second data source are identified. Referring again to the example at FIG. 3, the calculation scenario models the flow of execution, so in the calculation scenario the union operator 355 is identified having union inputs from each of the three data sources 390A-C. In the example of FIG. 3, the union node 355 and sales_a attribute are both activated (e.g., flagged as described with respect to 199) for union input pruning.

At 515, it is determined, determining, based on metadata associated with the first data source, that the key figure attribute at the first data source does not correspond to null, and at 520, it is determined, based on metadata associated with the second data source, that the key figure attribute at the second data source corresponds to null. Referring again to FIG. 3, the calculation engine may for example determine for example that the key figure attribute sales_a does not correspond to null at the first data source 390A (based on metadata 352A) but corresponds to null at the second and third data sources 390B-C (based on metadata 352B-C).

At 525, the second union input is pruned, based on the determining at 520, to inhibit selection from the second data source. Referring again to FIG. 3, the calculation engine may prune from the query execution (or plan) the union input at 360B to union operator 355 (as well as union input 360C in this example). In this example, only union input 360A is remains after pruning.

At 530, a column (which corresponds to the key figure attribute) is selected from the first data source. Referring again to FIG. 3, the query execution may perform a select for a column including the first attribute sales_a at the data source 390A. And at 535, the selected column data may be used in part to respond to the query.

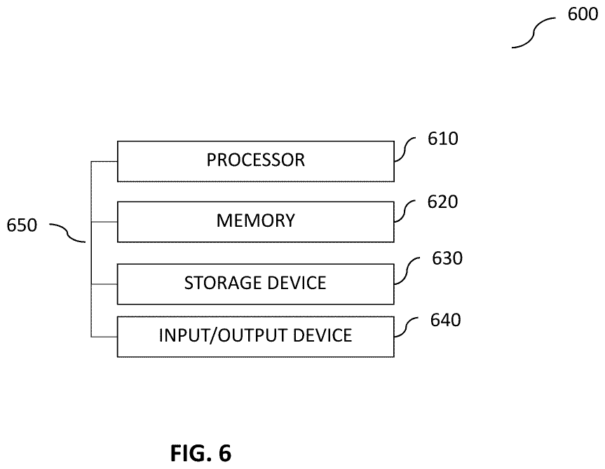

In some implementations, the current subject matter may be configured to be implemented in a system 600, as shown in FIG. 6. To illustrate further system 600 may further an operating system, a hypervisor, and/or other resources, to provide virtualize physical resources (e.g., via virtual machines). The system 600 may include a processor 610, a memory 620, a storage device 630, and an input/output device 640. Each of the components 610, 620, 630 and 640 may be interconnected using a system bus 650. The processor 610 may be configured to process instructions for execution within the system 600. In some implementations, the processor 610 may be a single-threaded processor. In alternate implementations, the processor 610 may be a multi-threaded processor.

The processor 610 may be further configured to process instructions stored in the memory 620 or on the storage device 630, including receiving or sending information through the input/output device 640. The memory 620 may store information within the system 600. In some implementations, the memory 620 may be a computer-readable medium. In alternate implementations, the memory 620 may be a volatile memory unit. In yet some implementations, the memory 620 may be a non-volatile memory unit. The storage device 630 may be capable of providing mass storage for the system 600. In some implementations, the storage device 630 may be a computer-readable medium. In alternate implementations, the storage device 630 may be a floppy disk device, a hard disk device, an optical disk device, a tape device, non-volatile solid state memory, or any other type of storage device. The input/output device 640 may be configured to provide input/output operations for the system 600. In some implementations, the input/output device 640 may include a keyboard and/or pointing device. In alternate implementations, the input/output device 640 may include a display unit for displaying graphical user interfaces.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1: A system comprising: at least one hardware data processor; and at least one memory storing instructions which, when executed by the at least one data processor, result in operations comprising: receiving a query associated with a plurality of data sources, wherein the query includes a first attribute; identifying that a query operator, which is associated with execution of the query and the first attribute, includes a first input from a first data source of the plurality of data sources and a second input from a second data source of the plurality of data sources; determining that the first attribute at the first data source does not correspond to null; determining that the first attribute at the second data source corresponds to null; pruning, based on the determined null, the second input from the second data source to inhibit a select from the second data source; in response to the pruning, performing the query operator by selecting, from the first data source, a column corresponding to the first attribute; and in response to the performing, responding to the query with a result using at least in part the selected column corresponding to the first attribute at the first data source.

Example 2: The system of Example 1, wherein the query is associated with a calculation scenario.

Example 3: The system of any of Examples 1-2, wherein the first attribute comprises a key figure attribute.

Example 4: The system of any of Examples 1-3, wherein the key figure attribute is flagged in the calculation scenario to allow pruning of the second input to the query operator.

Example 5: The system of any of Examples 1-4, wherein the query operator is flagged to allow pruning.

Example 6: The system of any of Examples 1-5, wherein metadata is used to determine that the key figure attribute at the first data source does not correspond to null.

Example 7: The system of any of Examples 1-6, wherein metadata is used to determine that the key figure attribute at the first data source does correspond to null.

Example 8: The system of any of Examples 1-7, wherein the query operator comprises a union operator, wherein the union operator includes the first input from the first data source and the second input from the second data source.

Example 9: The system of any of Examples 1-8, wherein the query associated with the calculation scenario further defines a view attribute associated with at least the first data source and the second data source.

Example 10: A method comprising: receiving a query associated with a plurality of data sources, wherein the query includes a first attribute; identifying that a query operator, which is associated with execution of the query and the first attribute, includes a first input from a first data source of the plurality of data sources and a second input from a second data source of the plurality of data sources; determining that the first attribute at the first data source does not correspond to null; determining that the first attribute at the second data source corresponds to null; pruning, based on the determined null, the second input from the second data source to inhibit a select from the second data source; in response to the pruning, performing the query operator by selecting, from the first data source, a column corresponding to the first attribute; and in response to the performing, responding to the query with a result using at least in part the selected column corresponding to the first attribute at the first data source.

Example 11: The method of Example 10, wherein the query is associated with a calculation scenario.

Example 12: The method of any of Examples 10-11, wherein the first attribute comprises a key figure attribute.

Example 13: The method of any of Examples 10-12, wherein the key figure attribute is flagged in the calculation scenario to allow pruning of the second input to the query operator.

Example 14: The method of any of Examples 10-13, wherein the query operator is flagged to allow pruning.

Example 15: The method of any of Examples 10-14, wherein metadata is used to determine that the key figure attribute at the first data source does not correspond to null.

Example 16: The method of any of Examples 10-15, wherein metadata is used to determine that the key figure attribute at the first data source does correspond to null.

Example 17: The method of any of Examples 10-16, wherein the query operator comprises a union operator, wherein the union operator includes the first input from the first data source and the second input from the second data source.

Example 18: The method of any of Examples 10-17, wherein the query associated with the calculation scenario further defines a view attribute associated with at least the first data source and the second data source.

Example 19: A non-transitory computer-readable storage medium including instructions which, when executed by at least one data processor, result in operations comprising: receiving a query associated with a plurality of data sources, wherein the query includes a first attribute; identifying that a query operator, which is associated with execution of the query and the first attribute, includes a first input from a first data source of the plurality of data sources and a second input from a second data source of the plurality of data sources; determining that the first attribute at the first data source does not correspond to null; determining that the first attribute at the second data source corresponds to null; pruning, based on the determined null, the second input from the second data source to inhibit a select from the second data source; in response to the pruning, performing the query operator by selecting, from the first data source, a column corresponding to the first attribute; and in response to the performing, responding to the query with a result using at least in part the selected column corresponding to the first attribute at the first data source.

Example 20: The non-transitory computer-readable storage medium of Example 19, wherein the query operator comprises a union operator, wherein the union operator includes the first input from the first data source and the second input from the second data source.

Without in any way limiting the scope, interpretation, or application of the claims appearing below, a technical effect of one or more of the example embodiments disclosed herein is more efficient execution of complex queries.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed is:

1. A system comprising:
at least one hardware data processor; and
at least one memory storing instructions which, when executed by the at least one data processor, result in operations comprising:
receiving a query associated with a plurality of data sources, wherein the query includes a first attribute;
identifying that a query operator, which is associated with execution of the query and the first attribute, includes a first input from a first data source of the plurality of data sources and a second input from a second data source of the plurality of data sources;
determining that the first attribute at the first data source does not correspond to null;
determining that the first attribute at the second data source corresponds to null;
pruning, based on the determined null, the second input from the second data source to inhibit a select from the second data source;
in response to the pruning, performing the query operator by selecting, from the first data source, a column corresponding to the first attribute; and
in response to the performing, responding to the query with a result using at least in part the selected column corresponding to the first attribute at the first data source.

2. The system of claim 1, wherein the query is associated with a calculation scenario.

3. The system of claim 2, wherein the first attribute comprises a key figure attribute.

4. The system of claim 3, wherein the key figure attribute is flagged in the calculation scenario to allow pruning of the second input to the query operator.

5. The system of claim 3, wherein the query operator is flagged to allow pruning of the second input to the query operator.

6. The system of claim 3, wherein metadata is used to determine that the key figure attribute at the first data source does not correspond to null.

7. The system of claim 3, wherein metadata is used to determine that the key figure attribute at the first data source does correspond to null.

8. The system of claim 1, wherein the query operator comprises a union operator, wherein the union operator includes the first input from the first data source and the second input from the second data source.

9. The system of claim 2, wherein the query associated with the calculation scenario further defines a view attribute associated with at least the first data source and the second data source.

10. A method comprising:
receiving a query associated with a plurality of data sources, wherein the query includes a first attribute;
identifying that a query operator, which is associated with execution of the query and the first attribute, includes a first input from a first data source of the plurality of data sources and a second input from a second data source of the plurality of data sources;
determining that the first attribute at the first data source does not correspond to null;
determining that the first attribute at the second data source corresponds to null;
pruning, based on the determined null, the second input from the second data source to inhibit a select from the second data source;
in response to the pruning, performing the query operator by selecting, from the first data source, a column corresponding to the first attribute; and
in response to the performing, responding to the query with a result using at least in part the selected column corresponding to the first attribute at the first data source.

11. The method of claim 10, wherein the query is associated with a calculation scenario.

12. The method of claim 11, wherein the first attribute comprises a key figure attribute.

13. The method of claim 12, wherein the key figure attribute is flagged in the calculation scenario to allow pruning of the second input to the query operator.

14. The method of claim 12, wherein the query operator is flagged to allow pruning.

15. The method of claim 12, wherein metadata is used to determine that the key figure attribute at the first data source does not correspond to null.

16. The method of claim 12, wherein metadata is used to determine that the key figure attribute at the first data source does correspond to null.

17. The method of claim 10, wherein the query operator comprises a union operator, wherein the union operator includes the first input from the first data source and the second input from the second data source.

18. The method of claim 11, wherein the query associated with the calculation scenario further defines a view attribute associated with at least the first data source and the second data source.

19. A non-transitory computer-readable storage medium including instructions which, when executed by at least one data processor, result in operations comprising:
receiving a query associated with a plurality of data sources, wherein the query includes a first attribute;
identifying that a query operator, which is associated with execution of the query and the first attribute, includes a first input from a first data source of the plurality of data sources and a second input from a second data source of the plurality of data sources;
determining that the first attribute at the first data source does not correspond to null;
determining that the first attribute at the second data source corresponds to null;
pruning, based on the determined null, the second input from the second data source to inhibit a select from the second data source;
in response to the pruning, performing the query operator by selecting, from the first data source, a column corresponding to the first attribute; and
in response to the performing, responding to the query with a result using at least in part the selected column corresponding to the first attribute at the first data source.

20. The non-transitory computer-readable storage medium of claim 19, wherein the query operator comprises a union operator, wherein the union operator includes the first input from the first data source and the second input from the second data source.
